(19) United States
(12) Patent Application Publication
(10) Pub. No.: US 2023/0368666 A1
(43) Pub. Date: Nov. 16, 2023

(54) Tracking Application Device

(71) Applicant: Tinika Taylor, Atoka, TN (US)

(72) Inventor: Tinika Taylor, Atoka, TN (US)

(21) Appl. No.: 18/315,158

(22) Filed: May 10, 2023

Related U.S. Application Data
(60) Provisional application No. 63/339,998, filed on May 10, 2022.

(51) Int. Cl. G08G 1/13

(52) U.S. Cl. CPC G08G 1/13

(57) ABSTRACT

The present invention relates to a novel tracking application device. The device is a unique software application accessible on a smartphone, tablet, laptop, or desktop computer. The application allows bus riding children and/or parents to observe the location of a school bus in real time. The application may also be used for public transportation buses. Users can track bus locations via GPS and identify their immediate locations on a digital map in real time. Once a bus is close to a desired bus stop, a user can leave their home to wait for the bus. Thus, a shorter wait period is exhibited, and a user does not have to worry about if a bus is going to be late or not show up at all.

### CROSS-REFERENCE TO RELATED APPLICATION

The present application claims priority to, and the benefit of, U.S. Provisional Application No. 63/339,998, which was filed on May 10, 2022, and is incorporated herein by reference in its entirety.

### FIELD OF THE INVENTION

The present invention relates generally to the field of tracking application devices. More specifically, the present invention relates to a tracking application device that provides users with a software application for tracking school and public bus locations. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in tracking application devices. Generally, young children may be forced to wait outdoors for their school bus and be at risk for getting caught out in inclement weather. Further, children waiting alone at a bus stop may get targeted for kidnapping if a parent is unaware that the bus is late or has not come. Waiting significant time for a school bus to show up can be frustrating, especially if it is raining or snowing.

Additionally, student transportation involves a lot of moving parts and can be a source of a district's greatest risk exposure. Knowing the location of a specific bus in real time is tremendously useful for the students and parents, as well as the school administration, both at the school level and the school district level. Thus, it would be tremendously valuable to have access to the real-time location of any school bus in a school district bus fleet. Besides providing a high level of security, such access monitoring minimizes the wait time for users when waiting for a bus, especially during inclement weather.

It is vital for security and other reasons described above to furnish a device and method that can enable school district transportation administrators and users to have real-time information as to the location of each of its school buses. Thus, users can track bus location via GPS and identify the immediate location on a digital map. Once a bus is chosen, the user leaves his or her home to wait, providing for a shorter wait period and not having to worry if the bus will show up or not.

Therefore, there exists a long-felt need in the art for a tracking application device that provides users with a software application for tracking school and public bus locations. There is also a long-felt need in the art for a tracking application device that allows users to only spend a short amount of time outdoors waiting for their bus by identifying its immediate location on a digital map. Further, there is a long-felt need in the art for a tracking application device that prevents people from waiting outside in inclement weather for a bus and helps reduce injuries or kidnapping of children waiting alone for their bus. Moreover, there is a long-felt need in the art for a device that enables users to access the application on a smartphone, tablet, or desktop computer. Further, there is a long-felt need in the art for a tracking application device that improves convenience when riding a school or public bus. Finally, there is a long-felt need in the art for a tracking application device that tracks bus locations via GPS.

The subject matter disclosed and claimed herein, in one embodiment thereof, comprises a tracking application device. The device is a unique software application accessible on a smartphone, tablet, laptop, or desktop computer. The application allows bus riding children and/or parents to observe the location of a school bus in real time. The application may also be used for public transportation buses. Users can track bus locations via GPS and identify their immediate locations on a digital map in real time. Once a bus is close to a desired bus stop, a user can leave their home to wait for the bus. Thus, a shorter wait period is exhibited, and a user does not have to worry about if a bus is going to be late or not show up at all.

In this manner, the tracking application device of the present invention accomplishes all of the foregoing objectives and provides users with a device that allows users to track the location of a school bus in real time. The device tracks bus locations via GPS and identifies their location via a digital map. The device can be accessed through a smartphone, tablet, or desktop computer.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tracking application device or system. The device is a unique software application accessible on a smartphone, tablet, laptop, or desktop computer. The application allows bus riding children and/or parents to observe the location of a school bus in real time. The application may also be used for public transportation buses. Users can track bus locations via GPS and identify their immediate locations on a digital map in real time. Once a bus is close to a desired bus stop, a user can leave their home to wait for the bus. Thus, a shorter wait period is exhibited, and a user does not have to worry about if a bus is going to be late or not show up at all.

In one embodiment, the tracking application device utilizes a smartphone, a tablet, a laptop, or desktop computer, etc., or any other suitable electronic device that has the required operating and memory parameters to support the software application of the present invention.

In one embodiment, the tracking application device comprises a GPS system to track bus locations in real time and a mobile computing device (i.e., smart phone, computer, tablet, etc.) comprising a software application for tracking bus locations in real time. The mobile or software application provides secure website and/or smart phone app access to users and/or parents as to bus location. In addition to these elements, the device of the present invention may also include: a web server and cloud database of bus identification and location data connectable to a mobile smartphone, portable tablet, or computer device.

In one embodiment of the invention, the GPS bus location from the GPS system and data management software is maintained on a Microsoft cloud server in a typical fashion, or other cloud server, such as the Adobe, Apple or Amazon cloud server, etc. A secure cloud server is used for the protection and security of bus identification and routes as well as information data stored on the cloud server. Thus, GPS bus location from the GPS system on bus identification and location, as well as route histories, is sent to the cloud server and collected. Conveniently, the data is stored and managed with a data management software or program to manage the collected bus identification data, GPS bus location data, and route history.

Typically, a cellular wireless data network embedded in the computer, tablet, or smartphone, etc., transmits both bus identification data and GPS coordinates at incremental times to a user and/or a school district cloud server. Such bus identification and location data can be processed by the school district and/or user via a cloud data management server. Generally, GPS is embedded in the computer, tablet, etc., as it is in a smartphone. On the smart device, a digital mapping service, such as Microsoft Bing mapping or other competitive mapping services overlays the GPS bus locations on the navigation mapping for visual tracking of the school bus locations as it proceeds on its route in real time. Thus, at any given time, the location of the bus can be determined.

The Global Positioning System (GPS) is a satellite-based navigation system made up of a network of 24 satellites placed into orbit by the U.S. Department of Defense. GPS was originally intended for military applications, but in the 1980s, the government made the system available for civilian use. The GPS system is embedded in many computers, tablets, smartphones, etc., and is used in navigation applications in these devices as well as vehicles and hunting or outdoor tracking devices.

Mobility is a key feature of the present invention as it permits flexibility. For example, if a school bus is picking up students in inclement weather, the student can track the school bus in real time and only spend a short amount of time outdoors waiting for their bus, by identifying its immediate location on a digital map.

The present invention offers a solution to tracking buses and focuses on finding the real-time location of a specific school bus or public bus. Thus, a given bus can be located while completing their route. Specifically, GPS coordinates are used to locate the bus via the GPS embedded in the smartphone, computer, tablet, etc. A software application for users and/or parents, which is accessed via a smartphone, tablet, computer, etc., then maps and displays bus locations in real time. Further, optional text message notifications can be utilized to notify users and/or parents of buses entering and exiting their stop.

Generally, the bus driver is assigned a bus route on a daily basis, periodically, or for the full school/calendar year. Further, most bus drivers have a regularly scheduled bus route. As the bus proceeds along the route, the GPS system tracks the bus location in real time and displays the location on a digital map on the software application. Further, the device can be programmed to send a text message or other electronic notification when the bus reaches each assigned stop on the assigned route. Additionally, the device can be programmed to send an alert to a user when the bus has arrived at a preprogrammed distance from an assigned stop.

In yet another embodiment, the tracking application device comprises a plurality of indicia.

In yet another embodiment, a method of tracking a bus location in real time using a software application is disclosed. The method includes the steps of providing a tracking application device comprising a software application that tracks bus locations via GPS and identifies their locations on a digital map in real time. The method also comprises accessing the software application. Further, the method comprises tracking a bus location in real time via GPS on the application. Finally, the method comprises identifying the bus location via a digital map on the application.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one embodiment of the tracking application device of the present invention showing a child using the application prior to boarding a school bus in accordance with the disclosed architecture;

FIG. 2 illustrates a side perspective view of one embodiment of the tracking application device of the present invention showing how the application shows the bus location in real time in accordance with the disclosed architecture;

FIG. 3 illustrates a side perspective view of one embodiment of the tracking application device of the present invention showing a parent monitoring the school bus on a smartphone in accordance with the disclosed architecture;

FIG. 4 illustrates a side perspective view of one embodiment of the tracking application device of the present invention showing how the application can be used on a computer in accordance with the disclosed architecture;

FIG. 5 illustrates a front perspective view of one embodiment of the tracking application device of the present invention showing the school bus and public bus options available in the application in accordance with the disclosed architecture;

FIG. 6 illustrates a flowchart showing the method of tracking a bus location in real time using a software application in accordance with the disclosed architecture;

FIG. 7 is a schematic diagram illustrating one embodiment of the software application for tracking bus locations of the present invention in accordance with the disclosed architecture; and

FIG. 8 illustrates an exemplary user device that is used for installing the software application for tracking bus locations of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a tracking application device that provides users with a software application for tracking school and public bus locations. There is also a long-felt need in the art for a tracking application device that allows users to only spend a short amount of time outdoors waiting for their bus by identifying its immediate location on a digital map. Further, there is a long-felt need in the art for a tracking application device that prevents people from waiting outside in inclement weather for a bus and helps reduce injuries or kidnapping of children waiting alone for their bus. Moreover, there is a long-felt need in the art for a device that enables users to access the application on a smartphone, tablet, or desktop computer. Further, there is a long-felt need in the art for a tracking application device that improves convenience when riding a school or public bus. Finally, there is a long-felt need in the art for a tracking application device that tracks bus locations via GPS.

The present invention, in one exemplary embodiment, is a novel tracking application device. The device is a unique software application accessible on a smartphone, tablet, laptop, or desktop computer. The application allows bus riding children and/or parents to observe the location of a school bus in real time. The application may also be used for public transportation buses. Users can track bus locations via GPS and identify their immediate locations on a digital map in real time. Once a bus is close to a desired bus stop, a user can leave their home to wait for the bus. Thus, a shorter wait period is exhibited, and a user does not have to worry about if a bus is going to be late or not show up at all. The present invention also includes a novel method of tracking a bus location in real time using a software application. The method includes the steps of providing a tracking application device comprising a software application that tracks bus locations via GPS and identifies their locations on a digital map in real time. The method also comprises accessing the software application. Further, the method comprises tracking a bus location in real time via GPS on the application. Finally, the method comprises identifying the bus location via a digital map on the application.

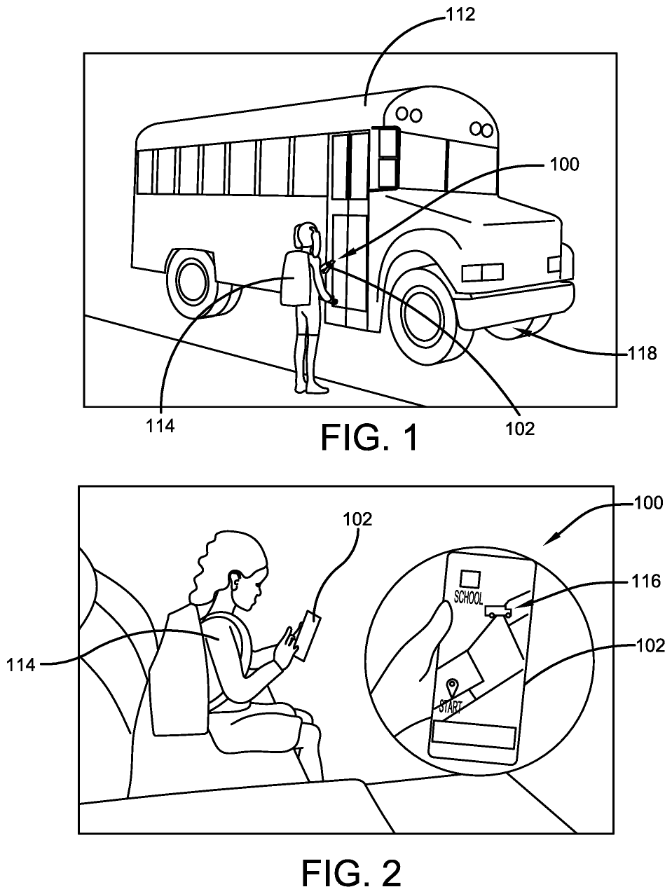

Referring initially to the drawings, FIG. 1 illustrates a perspective view of one embodiment of the tracking application device 100 of the present invention. In the present embodiment, the tracking application device 100 is a software application that allows bus riding users 114 to observe the location of a bus 112 in real time. Specifically, the tracking application device 100 is a unique software application accessible on a smartphone, tablet, laptop, or desktop computer (i.e., user device 102). Users 114 can track bus locations via GPS and identify their immediate locations on a digital map 116 in real time. Once a bus 112 is close to a desired bus stop 118, a user 114 can leave their home to wait for the bus 112. Thus, a shorter wait period is exhibited and a user 114 does not have to worry about if a bus 112 is going to be late or not show up at all.

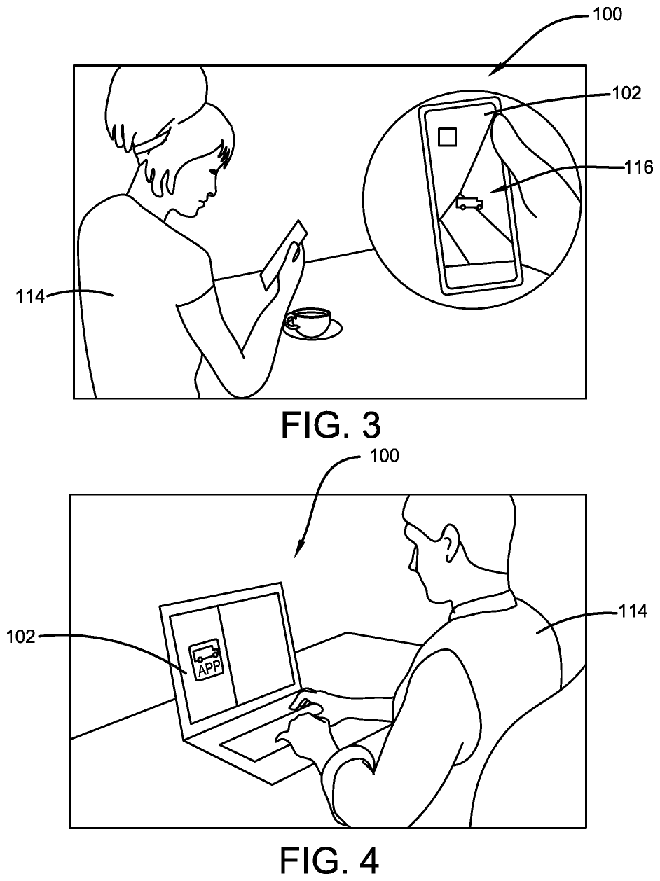

As shown in FIGS. 2-4, the tracking application device 100 utilizes a smartphone, a tablet, a laptop, desktop computer, etc. (i.e., user device 102), or any other suitable electronic device that has the required operating and memory parameters to support the software application of the present invention.

Generally, the tracking application device 100 is a software application that comprises a GPS system to track bus locations in real time and a mobile computing device 102 (i.e., smart phone, computer, tablet, etc.) for tracking bus locations in real time. The mobile or software application provides secure website and/or smart phone app access to users 114 and/or parents as to bus location. In addition to these elements, the device 100 of the present invention may also include: a web server/application server 108 and cloud database 110 of bus identification route histories, and location data connectable to the mobile smartphone, portable tablet, or computer device 102.

In one embodiment of the invention, the GPS bus location from the GPS system and data management software is maintained on a Microsoft cloud server in a typical fashion, or other cloud server, such as the Adobe, Apple or Amazon cloud server, etc. A secure cloud server is used for the protection and security of bus identification and routes, and information data stored on the cloud server. Thus, GPS bus location from the GPS system on bus identification and location, as well as route histories, is sent to the cloud server and collected. Conveniently, the data is stored and managed with a data management software or program to manage the collected bus identification data, GPS bus location data, and route history.

Typically, a cellular wireless data network 106 embedded in the computer, tablet or smartphone, etc. (i.e., user device 102), transmits both bus identification data and GPS coordinates at incremental times to a user 114 and/or a school district cloud server. Such bus identification and location data can be processed by the school district and/or user 114 via a cloud data management server. Generally, GPS is embedded in the computer, tablet, etc. 102, as it is in a smartphone. On the smart device 102, a digital mapping service, such as Microsoft Bing mapping or other competitive mapping services overlays the GPS bus locations on the navigation mapping for visual tracking of the school bus location as it proceeds on its route in real time. Thus, at any given time, the location of the bus 112 can be determined.

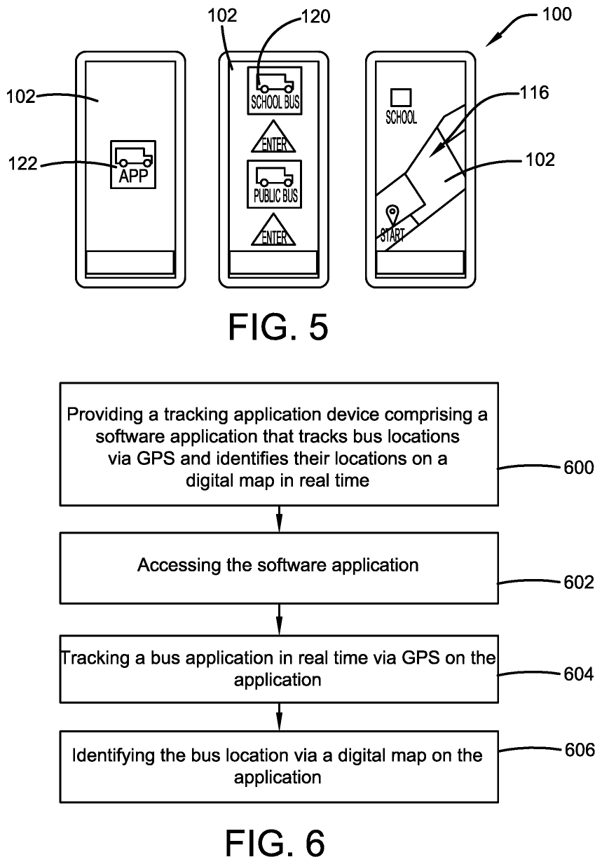

As shown in FIG. 5, mobility is a key feature of the present invention as it permits flexibility. For example, if a school bus 112 is picking up students 114 in inclement weather, the student 114 can track the school bus 112 in real time and only spend a short amount of time outdoors waiting for their bus 112 in inclement weather, by identifying its immediate location on a digital map 116.

Accordingly, the present invention offers a solution to tracking buses 112 and focuses on finding the real-time location of a specific school bus or public bus 112. Thus, a given bus 112 can be located while completing their route. Specifically, GPS coordinates are used to locate the bus 112 via the GPS embedded in the smartphone, computer, tablet, etc. (i.e., user device 102). A software application for users 114 and/or parents, which is accessed via a smartphone, tablet, computer, etc. 102, then maps and displays bus locations in real time. Further, optional text message notifications 120 can be utilized to notify users 114 and/or parents of buses 112 entering and exiting their stop 118.

Generally, the bus driver is assigned a bus route on a daily basis, periodically, or for the full school/calendar year. Further, most bus drivers have a regularly scheduled bus route. As the bus 112 proceeds along the route, the GPS system tracks the bus location in real time and displays the location on a digital map 116 on the software application. Further, the device 100 can be programmed to send a text message 120 or other electronic notification when the bus 112 reaches each assigned stop 118 on the assigned route. Additionally, the device 100 can be programmed to send an alert 120 to a user 114 when the bus 112 has arrived at a preprogrammed distance from an assigned stop 118.

In yet another embodiment, the tracking application device 100 comprises a plurality of indicia 122. Specifically, the software application of the device 100 may include advertising, trademark, other letters, designs, or characters, printed, painted, stamped, or integrated into the software application, or any other indicia 122 as is known in the art. Specifically, any suitable indicia 122 as is known in the art can be included, such as, but not limited to, patterns, logos, emblems, images, symbols, designs, letters, words, characters, animals, advertisements, brands, etc., that may or may not be bus, route, or brand related.

FIG. 6 illustrates a flowchart of the method of tracking a bus location in real time using a software application. The method includes the steps of at 600, providing a tracking application device comprising a software application that tracks bus locations via GPS and identifies their locations on a digital map in real time. The method also comprises at 602, accessing the software application. Further, the method comprises at 604, tracking a bus location in real time via GPS on the application. Finally, the method comprises at 606, identifying the bus location via a digital map on the application.

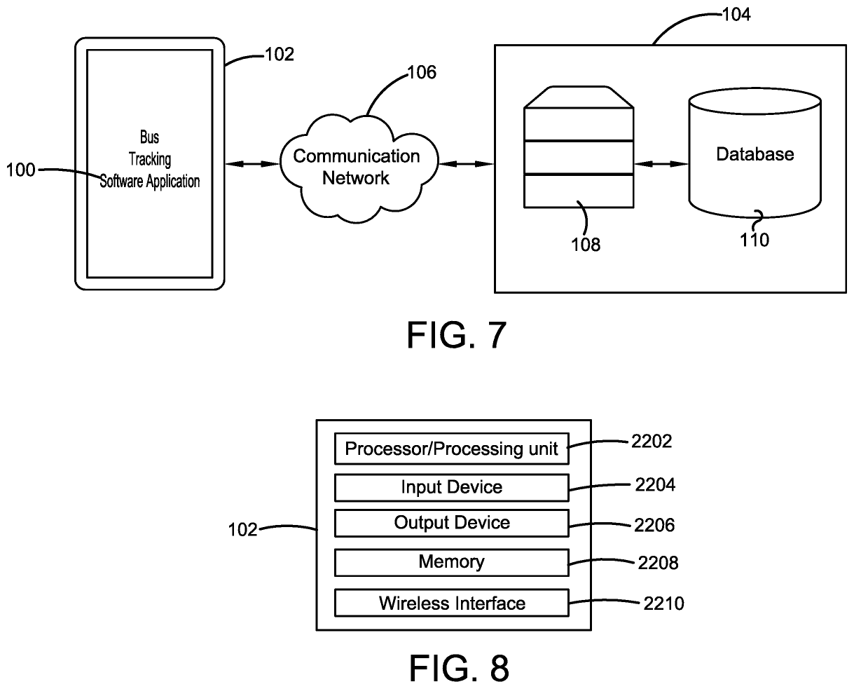

FIG. 7 is a schematic diagram illustrating one embodiment of the software application for tracking bus locations 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the internet. The user device 102 is capable of facilitating a user to input data, receive data, and/or transmit data within the application 100. It will be apparent to a user of ordinary skill in the art that the user may be any person using the application 100, without deviating from the scope of the disclosure. Examples of the user device 102 may include, but are not limited to, a desktop, a notebook, a laptop, a handheld computer, a touch sensitive device, a tablet, a computing device, a smart-phone, a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a .NET framework, a personal home page (PHP) framework, or any web-application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users' account information from the application 100, as well as bus identification and locations, and route histories. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channels thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the internet, a fiber optic network, a coaxial cable network, an infrared (IR) network, a radio frequency (RF) network, and a combination thereof. Embodiments of the present invention are intended to include or otherwise cover, any type of communication channel, including known, related art, and/or later developed technologies.

FIG. 8 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications include the software application 100.

The user device 102 comprises an input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore, not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 are utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communication between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “tracking application device”, “tracking device”, and “device” are interchangeable and refer to the tracking application device 100 of the present invention.

Notwithstanding the foregoing, the tracking application device 100 of the present invention can be of any suitable size and configuration as is known in the art without affecting the overall concept of the invention, provided that it accomplishes the above-stated objectives. One of ordinary skill in the art will appreciate that the tracking application device 100 as shown in FIGS. 1-6 are for illustrative purposes only, and that many other sizes and shapes of the tracking application device 100 are well within the scope of the present disclosure. Although the dimensions of the tracking application device 100 are important design parameters for user convenience, the tracking application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tracking application device that allows a user to observe a bus location in real time, the tracking application device comprising:
a software application; and
a GPS system;
wherein the software application is accessible on a smart device; and
further wherein the GPS system identifies the bus location in real time.

2. The tracking application device of claim 1, wherein the smart device is a smartphone, a tablet, a laptop or a desktop computer.

3. The tracking application device of claim 2, wherein the user tracks the bus location via the GPS system.

4. The tracking application device of claim 3, wherein the user identifies an immediate location of the bus on a digital map in real time.

5. The tracking application device of claim 4, wherein the software application provides secure web site or smart phone application access by the user and a user's parents for the bus location.

6. The tracking application device of claim 5 further comprising a web server and a cloud database of bus identification and location data connectable to the smart device.

7. The tracking application device of claim 6, wherein a secure smart server is used for protection and security of bus identification and routes.

8. The tracking application device of claim 7, wherein bus locations identified from the GPS system, bus identifications, and route histories are sent to the secure cloud server and collected.

9. The tracking application device of claim 8, wherein data is stored and managed with a data management software or program.

10. The tracking application device of claim 9, wherein a cellular wireless data network embedded in the smart device transmits both bus identification data and GPS coordinates at incremental times to the user.

11. The tracking application device of claim 10, wherein a digital mapping service overlays the bus location identified from the GPS system on the digital map for visual tracking of the school bus location as the bus proceeds on its route in real time.

12. The tracking application device of claim 11, wherein the tracking application device can be programmed to send a text message to notify users of buses entering and exiting their stop.

13. A tracking application device that allows a user to observe a bus location in real time, the tracking application device comprising:
a software application; and
a GPS system; and
wherein the software application is accessible on a smart device;
wherein the user tracks the bus locations via the GPS system;
wherein the user identifies a bus immediate location on a digital map in real time;
wherein the software application provides secure website or smart phone application access by the user and a parent of the user; and
further wherein a cellular wireless data network embedded in the smart device transmits both bus identification data and GPS coordinates at incremental times to the user.

14. The tracking application device of claim 13 further comprising a plurality of indicia.

15. The tracking application device of claim 13, wherein the tracking application device can be programmed to send a text message to notify the user of buses entering and exiting their stop.

16. The tracking application device of claim 13, wherein the smart device is a smartphone, a tablet, a laptop or a desktop computer.

17. The tracking application device of claim 13, wherein a secure cloud server is used for protection and security of bus identification and routes.

18. The tracking application device of claim 17, wherein bus locations identified from the GPS system, bus identifications, and route histories are sent to the secure cloud server and collected.

19. The tracking application device of claim 18, wherein data is stored and managed with a data management software or program.

20. A method of tracking a bus location in real time using a software application, the method comprising the following steps:
providing a tracking application device comprising a software application and a GPS;
accessing the software application;
tracking the bus location in real time via the GPS on the tracking application device; and
identifying the bus location via a digital map on the software application.
